(19) United States
(12) Patent Application Publication
(10) Pub. No.: US 2020/0046024 A1
(43) Pub. Date: Feb. 13, 2020

(54) ELECTRONIC CIGARETTE, ATOMIZER CORE THEREOF AND ATOMIZER THEREOF

(71) Applicant: Shenzhen Smoore Technology Limited, Shenzhen (CN)

(72) Inventor: Zhiping Chen, Shenzhen (CN)

(73) Assignee: Shenzhen Smoore Technology Limited, Shenzhen (CN)

(21) Appl. No.: 16/343,081

(22) PCT Filed: Oct. 26, 2016
(86) PCT No.: PCT/CN2016/103355

§ 371 Date: Apr. 18, 2019

(51) Int. Cl. A24F 47/00; A24F 7/02

(52) U.S. Cl. CPC A24F 47/008; F16J 15/002; A24F 7/02

(57) ABSTRACT

An electronic cigarette, an atomizer core of which comprising a main body portion and a mouthpiece portion, the main body portion being provided therein with a liquid storage chamber and an airflow channel that are separated from each other, the main body portion being configured to be located in a receiving chamber of a housing; the mouthpiece portion is slidably connected to the main body portion, at least a portion of the mouthpiece portion being located outside the receiving chamber; a suction hole is provided on the mouthpiece portion, and is in communication with the airflow channel when the mouthpiece portion is located in a first position relative to the main body portion.

### TECHNICAL FILED

The present disclosure relates to the technical field of smoking devices, and more particularly, to an electronic cigarette, an atomizing core and an atomizer thereof.

### BACKGROUND

Electronic cigarettes are also known as virtual cigarettes and electronic atomizers. Electronic cigarettes have a similar appearance and taste to cigarettes, but generally do not contain harmful components such as tar and suspended particles in cigarettes.

Electronic cigarettes generally include an atomizer storing e-liquid and a battery assembly, and many electronic cigarettes use a refillable atomizer to which the e-liquid can be injected when exhausted. However, in use of the conventional refillable atomizer, a liquid storage chamber is easily opened due to misoperation, resulting in liquid leakage.

### SUMMARY

Accordingly, in view of the aforementioned problems, it is necessary to provide an electronic cigarette, an atomizing core, and an atomizer thereof, which are capable of avoiding opening of a liquid storage chamber due to misoperation.

An atomizing core of an electronic cigarette configured to be connected to a housing of the electronic cigarette is provided, which includes:

a main body portion provided with a liquid storage chamber and an air flow passage that are separated from each other therein, the main body portion being disposed in a receiving chamber of the housing; and

a mouthpiece portion slidably connected to the main body portion. At least a portion of the mouthpiece portion is located outside the receiving chamber. The mouthpiece portion is provided with a suction hole, when the mouthpiece portion is located at a first position relative to the main body portion, the suction hole is in communication with the air flow passage. When the mouthpiece portion slides from the first position to a second position, a liquid injection position of the main body portion is exposed. The mouthpiece portion is provided with a stopper, when the mouthpiece portion is located at the first position relative to the main body portion and the main body portion is located in the receiving chamber, at least a portion of the stopper is located in the receiving chamber and the stopper abuts against the housing.

An atomizer of an electronic cigarette is also provided, which includes:

the atomizing core; and

a housing provided with a receiving chamber therein, the main body portion is located inside the receiving chamber, and at least a portion of the mouthpiece portion is located outside the receiving chamber. When the mouthpiece portion is located at the first position relative to the main body portion and the main body portion is located in the receiving chamber, at least a portion of the stopper is located in the receiving chamber and the stopper abuts against the housing.

An electronic cigarette is further provided, which includes:

the atomizer; and

a battery assembly located in the receiving chamber and electrically coupled to the atomizing core.

In the aforementioned electronic cigarette, the atomizing core, and the atomizer thereof, when the atomizing core is mounted on the housing for use, the stopper can be blocked by the housing so that the mouthpiece portion cannot slide relative to the main body portion, thereby ensuring that the liquid storage chamber cannot be opened due to misoperation in use, and avoiding liquid leakage.

### BRIEF DESCRIPTION OF DRAWINGS

To illustrate the technical solutions according to the embodiments of the present disclosure or in the prior art more clearly, the accompanying drawings for describing the embodiments or the prior art are introduced briefly in the following. Apparently, the accompanying drawings in the following description are only some embodiments of the present disclosure, and persons of ordinary skill in the art can derive other drawings from the accompanying drawings without creative efforts.

FIG. 1 is a perspective view of an electronic cigarette according to an embodiment;

FIG. 2 is a schematic view showing a disassembled state of the electronic cigarette of FIG. 1;

FIG. 3 is a partial cross-sectional view of the electronic cigarette shown of FIG.1;

FIG. 4 is an exploded view of an atomizing core in the electronic cigarette of FIG. 1;

FIG. 5 is an exploded view of the atomizing core in the electronic cigarette of FIG. 1 as viewed from another angle;

FIG. 6 is a cross-sectional view showing a mouthpiece portion of the atomizing core in the electronic cigarette of FIG. 1 located in a first position;

FIG. 7 is a cross-sectional view showing the mouthpiece portion of the atomizing core in the electronic cigarette of FIG. 1 located in a second position;

FIG. 8 is an exploded view of the mouthpiece portion in the electronic cigarette of FIG. 1; and

FIG. 9 is a perspective view of a circuit board in the electronic cigarette of FIG. 1.

### DETAILED DESCRIPTION OF THE EMBODIMENTS

For the convenience of understanding the present disclosure, an electronic cigarette, an atomizing core, and an atomizer thereof will be described more fully hereinafter with reference to the accompanying drawings. Preferred embodiments of the electronic cigarette, the atomizing core, and the atomizer thereof are illustrated in the accompanying drawings. The electronic cigarette, the atomizing core, and the atomizer thereof may, however, be embodied in many different forms and should not be construed as limited to the embodiments set forth herein. Rather, these embodiments are provided so that the disclosure of the electronic cigarette, the atomizing core, and the atomizer thereof will be thorough and complete.

Unless otherwise defined, all terms (including technical and scientific terms) used herein have the same meaning as commonly understood by one of ordinary skill in the art to which this disclosure belongs. The terms used herein in the specification of the electronic cigarette, the atomizing core, and the atomizer thereof are for the purpose of describing the specific embodiments only and are not intended to limit the present disclosure. As used herein, the term “and/or” includes any and all combinations of one or more of the associated listed items.

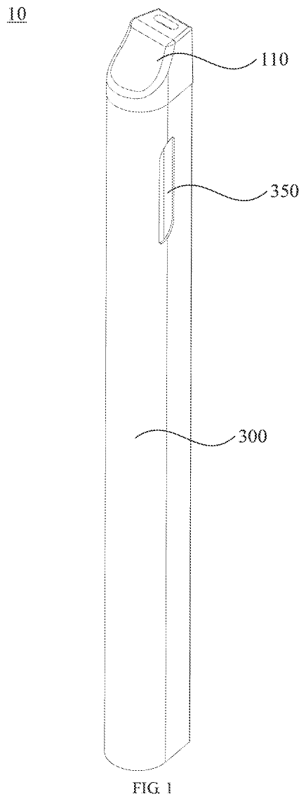

Referring to FIGS. 1 to 3, an electronic cigarette 10 according to an embodiment includes an atomizer 11 and a battery assembly 12. The atomizer 11 includes an atomizing core 100 and a housing 300. An interior of the housing 300 is provided with a receiving chamber 310, and the battery assembly 12 is disposed in the receiving chamber 310 and is electrically coupled to the atomizing core 100 to supply power to the atomizing core 100.

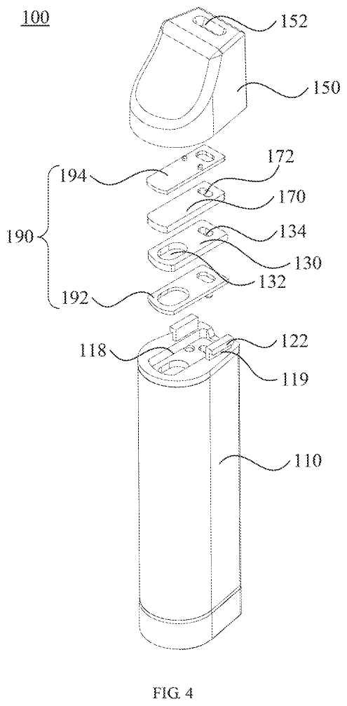

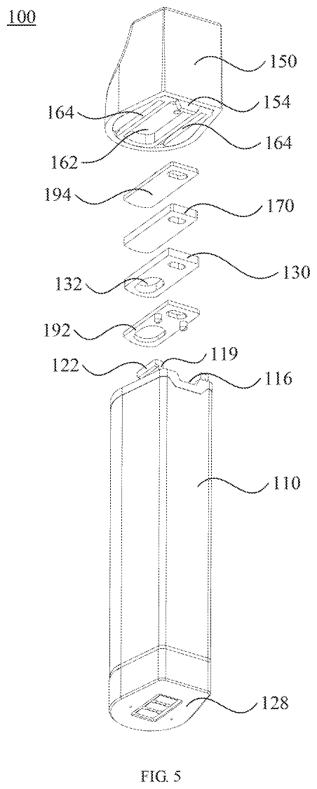

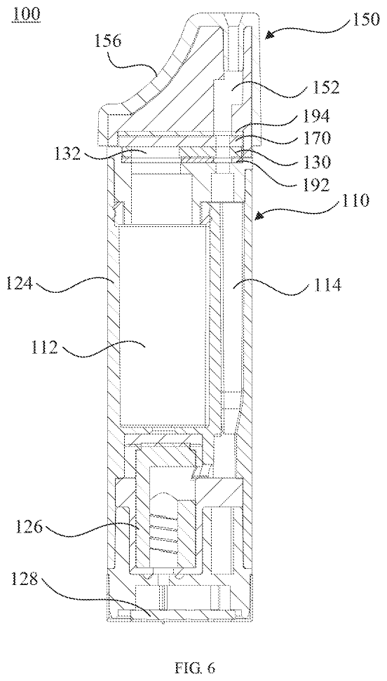

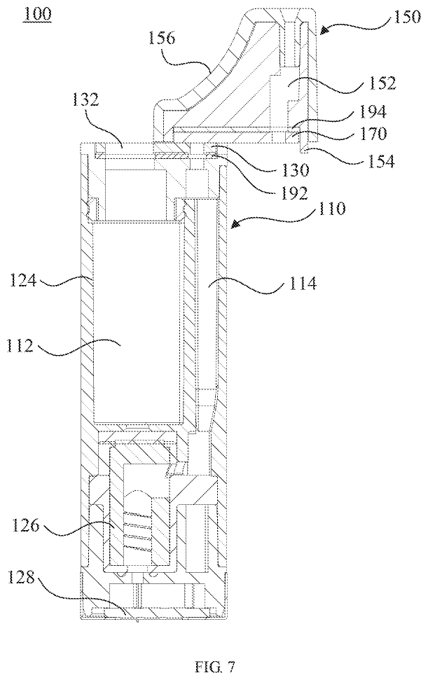

With reference to FIGS. 4 and 5, the atomizing core 100 includes a main body portion 110, a first ceramic sealing member 130, a mouthpiece portion 150, a second ceramic sealing member 170, and an elastic member 190. With further reference to FIG. 6, an interior of the main body portion 110 is provided with a liquid storage chamber 112 and an air flow passage 114 separated from each other. The first ceramic sealing member 130 is disposed on the main body portion 110 and is provided with a liquid injection hole 132. A position of the liquid injection hole 132 corresponds to a liquid injection position of the main body portion 110, and the liquid injection hole 132 is in communication with the liquid storage chamber 112. The mouthpiece portion 150 is slidably connected to the main body portion 110 and is provided with a suction hole 152. When the mouthpiece portion 150 is located at a first position relative to the main body portion 110, the suction hole 152 is in communication with the air flow passage 114. The second ceramic sealing member 170 is disposed on the mouthpiece portion 150, and a side surface of the second ceramic sealing member 170 slidably abuts against a side surface of the first ceramic sealing member 130. The second ceramic sealing member 170 covers the liquid injection hole 132 when the mouthpiece portion 150 is located at the first position. With further reference to FIG. 7, the liquid injection hole 132 is exposed when the mouthpiece portion 150 slides from the first position to a second position. The elastic member 190 is disposed between the first ceramic sealing member 130 and the main body portion 110 and/or between the second ceramic sealing member 170 and the mouthpiece portion 150, and the elastic member 190 presses the first ceramic sealing member 130 and the second ceramic sealing member 170 against each other.

In alternative embodiments, sealing members may also be made of other materials, such as silicone materials, or no elastic member may be provided, as long as the sliding connection can be achieved. In the present embodiment, the mouthpiece portion 150 is slidably connected to the main body portion 110, and the first ceramic sealing member 130 and the second ceramic sealing member 170 are engaged to achieve the sealing of the liquid injection hole 132. The elastic member 190 ensures that the first ceramic sealing member 130 and the second ceramic sealing member 170 are in close contact with each other, and no liquid leakage occurs between the first ceramic sealing member 130 and the second ceramic sealing member 170. In the aforementioned atomizing core 100, the liquid injection hole 132 can be exposed once the mouthpiece portion 150 is pushed open, which is convenient to operate and liquid can be quickly injected. In addition, since the ceramic materials are easy to be smoothed, the side surfaces of the first ceramic sealing member 130 and the second ceramic sealing member 170 which slidably abut against each other can be made smooth. Compared with the conventional sealing members made of silicone materials, the sealing members made of ceramic materials have much lower friction force, so that the mouthpiece portion 150 is more easily to slide relative to the main body portion 110, which is more convenient to operate. Moreover, ceramic materials have better wear resistance and therefore have longer service life.

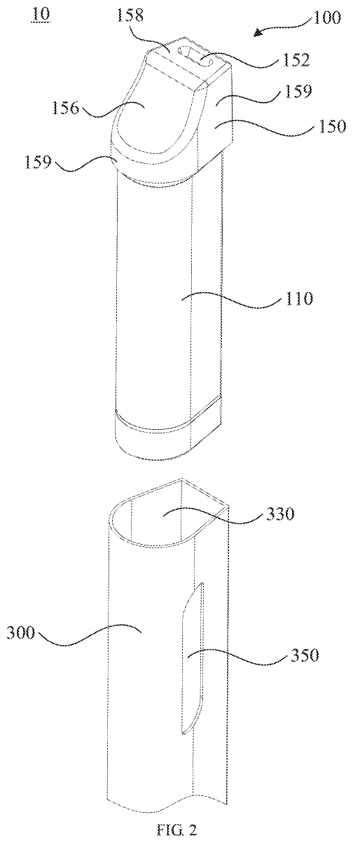

In a use state of the electronic cigarette 10, the main body portion 110 is located inside the receiving chamber 310 and at least a portion of the mouthpiece portion 150 is located outside the receiving chamber 310. With further reference to FIG. 2, in an embodiment, the housing 300 is further provided with a mounting opening 330 which is located at one end of the receiving chamber 310, and the main body portion 110 extends into the receiving chamber 310 through the mounting opening 330 and is detachably connected to the housing 300.

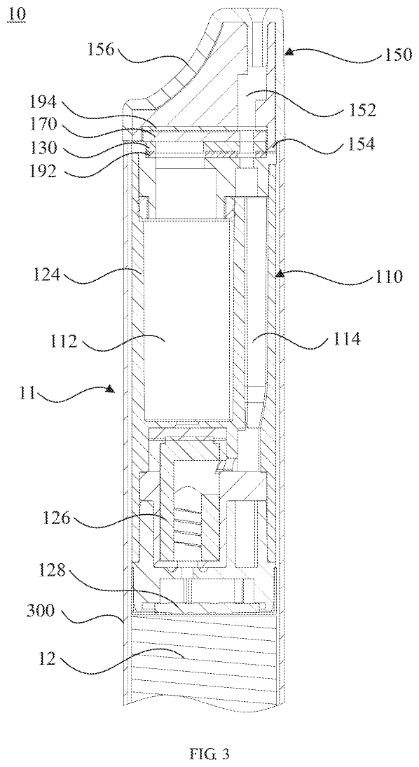

With further reference to FIGS. 3 and 5, in an embodiment, the mouthpiece portion 150 is provided with a stopper 154. When the mouthpiece portion 150 is located at the first position relative to the main body portion 110 and the main body portion 110 is located inside the receiving chamber 310, at least a portion of the stopper 154 is located inside the receiving chamber 310 and the stopper 154 abuts against an inner wall of the housing 300 at the mounting opening 330. In other embodiments, the stopper 154 can also abut against other positions of the housing 300, as long as the stopper 154 can be prevented from moving. Therefore, when the atomizing core 100 is mounted on the housing 300 for use, the stopper 154 can be blocked by the housing 300, and the mouthpiece portion 150 cannot slide relative to the main body portion 110, thereby ensuring that the liquid storage chamber 112 cannot be opened due to misoperation during use, avoiding liquid leakage. In addition, in an embodiment, the main body portion 110 is provided with an accommodating groove 116 for accommodating the stopper 154 at an edge of the main body portion 110. When the mouthpiece portion 150 is located at the first position relative to the main body portion 110, the stopper 154 can be located inside the accommodating groove 116.

With further reference to FIGS. 2, 6, and 7, in one of the embodiments, the mouthpiece portion 150 is provided with an arc surface 156 for pushing the mouthpiece portion 150 to slide relative to the main body portion 110. When a finger pushes the mouthpiece portion 150 to slide, since the acting surface is the arc surface 156, it is necessary to simultaneously provide a downward force to the mouthpiece portion 150 when pushed by the finger, thereby ensuring that the first ceramic sealing member 130 and the second ceramic sealing member 170 are in close contact with each other during the opening of the liquid injection hole 132, preventing the mouthpiece portion 150 from being inclined due to the pushing force, thereby further avoiding the liquid leakage in the long-term. In one embodiment, the arc surface 156 is concave toward an interior of the mouthpiece portion 150. Specifically, the mouthpiece portion 150 is further provided with a top surface 158 and four side surfaces 159, and an opening of the suction hole 152 is located on the top surface 158, and the four side surfaces 159 are sequentially connected and are perpendicular to the top surface 158. The top surface 158 and three of the side surfaces 159 are connected by the arc surface 156. In one embodiment, a shape of the arc surface 156 is adapted to a shape of the lips and is more comfortable to use.

Since the arc surface 156 is provided, a position at which the suction hole 152 is disposed is eccentrically disposed with respect to the mouthpiece portion 150. In an embodiment, the air flow passage 114 may be located at one side of the liquid storage chamber 112 to facilitate corresponding communication with the suction hole 152. In a further embodiment, the air flow passage 114 and the suction hole 152 may both have a flat cross-section so as to utilize space effectively and increase the ventilation area.

With further reference to FIGS. 5 and 6, in an embodiment, the first ceramic sealing member 130 is further provided with a first vent hole 134 which is in communication with the air flow passage 114. The second ceramic sealing member 170 is provided with a second vent hole 172 which is in communication with the suction hole 152. A position of the first vent hole 134 corresponds to a position of the second vent hole 172. When the mouthpiece is located at the first position, the first vent hole 134 is in communication with the second vent hole 172. The first ceramic sealing member 130 and the second ceramic sealing member 170 cover a larger area, which can improve the safety of the sliding and the stability of the sealing connection.

The elastic member 190 may be made of an elastic rubber, such as an elastic silicone. In other embodiments, a spring may also be used for the elastic member 190. The elastic member 190 may be disposed only between the first ceramic sealing member 130 and the main body portion 110 or may be disposed only between the second ceramic sealing member 170 and the mouthpiece portion 150. In the present embodiment, the above two positions are provided with the elastic member 190 and the sealing effect is better. Specifically, in an embodiment, the elastic member 190 includes a first elastic member 192 and a second elastic member 194. The first elastic member 192 is located between the first ceramic sealing member 130 and the main body portion 110, and the first elastic member 192 covers a side surface of the first ceramic sealing member 130 opposite to the side surface slidably abutting against the second ceramic sealing member 170. The second elastic member 194 is located between the second ceramic sealing member 170 and the main body portion 110, and the second elastic member 194 covers a side surface of the second ceramic sealing member 170 opposite to the side surface slidably abutting against the first ceramic sealing member 130. The first ceramic sealing member 130 and the second ceramic may be in a form of a sheet. The first elastic member 192 and the second elastic member 194 cover the sides of the first ceramic sealing member 130 and the second ceramic sealing member 170 away from each other, respectively, so that the effect of providing elastic force is better.

In addition, in an embodiment, the main body portion 110 is provided with a first mounting groove 118, and the first ceramic sealing member 130 and the first elastic member 192 are both located in the first mounting groove 118. The mouthpiece portion 150 is provided with a second mounting groove 162, and the second ceramic sealing member 170 and the second elastic member 194 are both located in the second mounting groove 162. The first mounting groove 118 and the second mounting groove 162 are provided to enable the first ceramic sealing member 130 and the first elastic member 192 to be firmly connected to the main body portion 110, and to enable the second ceramic sealing member 170 and the second elastic member 194 to be firmly connected to the mouthpiece portion 150.

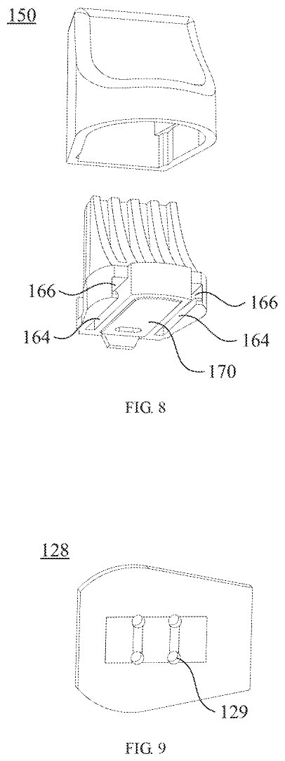

With further reference to FIGS. 4 and 8, in one of the embodiments, the main body portion 110 is provided with a slider 119, and the mouthpiece portion 150 is provided with a sliding groove 164. The slider 119 is located in the sliding groove 164 and is slidably connected to the mouthpiece portion 150. Two groups of the sliders 119 and the sliding grooves 164 may be provided, which are located on both sides of the first ceramic sealing member 130 and the second ceramic sealing member 170, respectively, to improve the stability of the sliding. In addition, in one embodiment, one side of the slider 119 is provided with a hook portion 122, and a side wall of the sliding groove 164 is provided with a latching groove 166. The hook portion 122 is located in the latching groove 166. When the slider 119 slides in the sliding groove 164, the hook portion 122 slides in the latching groove 166, so that the mouthpiece portion 150 and the main body portion 110 can be maintained in a connection state.

With further reference to FIG. 3, the main body portion 110 includes a housing body 124, an atomizing element 126, and a circuit board 128 configured to be electrically coupled to a battery assembly 12. The mouthpiece portion 150 is located at one end of the housing body 124, and the liquid storage chamber 112 and the air flow passage 114 are both formed in the housing body 124. The housing body 124 is further provided with an atomizing chamber therein. The atomizing element 126 is located within the atomizing chamber and is electrically coupled to the circuit board 128. With further reference to FIGS. 5 and 9, the other end of the housing body 124 is provided with an opening, the circuit board 128 is located in the housing body 124 and covers the opening of the housing body 124. The circuit board 128 is provided with an air inlet hole 129. By providing the air inlet hole 129 on the circuit board 128 for air intake, the structure is simple and is convenient for processing.

With further reference to FIGS. 1 and 2, in an embodiment, in order to observe the amount of e-liquid in the liquid storage chamber 112, at least a portion of a side wall of the liquid storage chamber 112 needs to be configured to be transparent or translucent, and the housing body 124 is provided with a window 350 for observing the amount of the e-liquid in the liquid storage chamber 112.

In addition, in an embodiment, the window 350 may include a first window and a second window disposed opposite to each other, and the first window and the second window are located at both sides of the main body portion 110, respectively. The first window and the second window are both elongated. Extending directions of the first window and the second window coincide with an extending direction of the housing 300. On the one hand, the first window and the second window are transparent opposite to each other, so that the amount of the e-liquid in the liquid storage chamber 112 can be clearly observed by the user. On the other hand, the atomizing core 100 can be gripped by the user from the first window and the second window with two fingers, respectively, so that the atomizing core 100 can be removed from the housing 300 conveniently.

The technical features of the embodiments described above can be arbitrarily combined. In order to make the description succinct, there is no describing of all possible combinations of the various technical features in the foregoing embodiments. It should be noted that there is no contradiction in the combination of these technical features which should be considered as the scope of the description.

Although the present disclosure is illustrated and described herein with reference to specific embodiments, the present disclosure is not intended to be limited to the details shown. It is to be noted that, various modifications may be made in the details within the scope and range of equivalents of the claims and without departing from the present disclosure. Therefore, the protection scope of the present disclosure shall be subject to the protection scope of the claims.

1. An atomizing core of an electronic cigarette, configured to be connected to a housing of the electronic cigarette, comprising:
a main body portion provided with a liquid storage chamber and an air flow passage that are separated from each other therein, the main body portion being disposed in a receiving chamber of the housing; and
a mouthpiece portion slidably connected to the main body portion, wherein at least a portion of the mouthpiece portion is located outside the receiving chamber; the mouthpiece portion is provided with a suction hole, when the mouthpiece portion is located at a first position relative to the main body portion, the suction hole is in communication with the air flow passage; when the mouthpiece portion slides from the first position to a second position, a liquid injection position of the main body portion is exposed; the mouthpiece portion is provided with a stopper, when the mouthpiece portion is located at the first position relative to the main body portion and the main body portion is located in the receiving chamber, at least a portion of the stopper is located in the receiving chamber and the stopper abuts against the housing.

2. The atomizing core of the electronic cigarette of claim 1, wherein the main body portion is provided with an accommodating groove at an edge thereof for accommodating the stopper.

3. The atomizing core of the electronic cigarette of claim 1, wherein the mouthpiece portion is provided with an arc surface configured to push the mouthpiece portion to slide relative to the main body portion.

4. The atomizing core of the electronic cigarette of claim 3, wherein a shape of the arc surface is adapted to a shape of lips.

5. The atomizing core of the electronic cigarette of claim 3, wherein the mouthpiece portion is further provided with a top surface and four side surfaces, an opening of the suction hole is located on the top surface, the four side surfaces are sequentially connected and are perpendicular to the top surface; the top surface and three of the side surfaces are connected by the arc surface.

6. The atomizing core of the electronic cigarette of claim 3, wherein the air flow passage is located at one side of the liquid storage chamber, the air flow passage has a flat cross-section, and the suction hole has a flat cross-section.

7. The atomizing core of the electronic cigarette of claim 1, further comprising:
a first ceramic sealing member disposed on the main body portion and provided with a liquid injection hole, wherein a position of the liquid injection hole corresponds to the liquid injection position of the main body portion, and the liquid injection hole is in communication with the liquid storage chamber;
a second ceramic sealing member disposed on the mouthpiece portion, wherein a side surface of the second ceramic sealing member slidably abuts against a side surface of the first ceramic sealing member; the second ceramic sealing member covers the liquid injection hole when the mouthpiece portion is located at the first position, and the liquid injection hole is exposed when the mouthpiece portion slides from the first position to the second position; and
an elastic member disposed between the first ceramic sealing member and the main body portion and/or between the second ceramic sealing member and the mouthpiece portion, wherein the elastic member presses the first ceramic sealing member and the second ceramic sealing member against each other.

8. The atomizing core of the electronic cigarette of claim 7, wherein the first ceramic sealing member is further provided with a first vent hole being in communication with the air flow passage; the second ceramic sealing member is provided with a second vent hole being in communication with the suction hole;
a position of the first vent hole corresponds to a position of the second vent hole; when the mouthpiece portion is located at the first position, the first vent hole is in communication with the second vent hole.

9. The atomizing core of the electronic cigarette of claim 7, wherein the elastic member is made of an elastic rubber.

10. The atomizing core of the electronic cigarette of claim 9, wherein the elastic rubber is an elastic silicone.

11. The atomizing core of the electronic cigarette of claim 9, wherein the elastic member comprises a first elastic member and a second elastic member;
wherein the first elastic member is located between the first ceramic sealing member and the main body portion, and the first elastic member covers a side surface of the first ceramic sealing member opposite to the side surface slidably abutting against the second ceramic sealing member;
the second elastic member is located between the second ceramic sealing member and the main body portion, and the second elastic member covers a side surface of the second ceramic sealing member opposite to the side surface slidably abutting against the first ceramic sealing member.

12. The atomizing core of the electronic cigarette of claim 9, wherein the main body portion is provided with a first mounting groove, and the first ceramic sealing member and the first elastic member are both located in the first mounting groove;
the mouthpiece portion is provided with a second mounting groove, and the second ceramic sealing member and the second elastic member are both located in the second mounting groove.

13. The atomizing core of the electronic cigarette of claim 1, wherein the main body portion is provided with a slider, the mouthpiece portion is provided with a sliding groove, and the slider is located in the sliding groove and is slidably connected to the mouthpiece portion.

14. The atomizing core of the electronic cigarette of claim 13, wherein one side of the slider is provided with a hook portion, and a side wall of the sliding groove is provided with a latching groove, and the hook portion is located in the latching groove, when the slider slides in the sliding groove, the hook portion slides in the latching groove.

15. The atomizing core of the electronic cigarette of claim 1, wherein the main body portion comprises a housing body, an atomizing element, and a circuit board configured to be electrically coupled to a battery assembly; the mouthpiece portion is located at one end of the housing body, and the liquid storage chamber and the air flow passage are both formed in the housing body; the housing body is further provided with an atomizing chamber therein; the atomizing element is located in the atomizing chamber and is electrically coupled to the circuit board;
the other end of the housing body is provided with an opening, the circuit board is located in the housing body and covers the opening of the housing body, and the circuit board is provided with an air inlet hole.

16. An atomizer of an electronic cigarette, comprising:
an atomizing core of claim 1, and
a housing provided with a receiving chamber therein, the main body portion being located inside the receiving chamber, and at least a portion of the mouthpiece portion being located outside the receiving chamber; wherein when the mouthpiece portion is located at the first position relative to the main body portion and the main body portion is located in the receiving chamber, at least a portion of the stopper is located in the receiving chamber and the stopper abuts against the housing.

17. The atomizer of the electronic cigarette of claim 16, wherein the housing is further provided with a mounting opening, the mounting opening is located at one end of the receiving chamber, and the main body portion extends into the receiving chamber through the mounting opening and is detachably connected to the housing; a position where the stopper abuts against the housing is located on an inner wall at the mounting opening.

18. The atomizer of the electronic cigarette of claim 16, wherein at least a portion of a side wall of the liquid storage chamber is transparent or translucent, and the housing body is provided with a window for observing the amount of e-liquid in the liquid storage chamber.

19. The atomizer of the electronic cigarette of claim 18, wherein the window include a first window and a second window disposed opposite to each other, the first window and the second window are located at both sides of the main body portion, respectively, and the first window and the second window are both elongated, and extending directions of the first window and the second window coincide with an extending direction of the housing.

20. An electronic cigarette comprising:
an atomizer of claim 16, and
a battery assembly located in the receiving chamber and electrically coupled to the atomizing core.
